(19) United States
(12) Patent Application Publication
(10) Pub. No.: US 2013/0164594 A1
(43) Pub. Date: Jun. 27, 2013

(54) ELECTRICAL ENERGY STORAGE CELL AND APPARATUS

(71) Applicant: Christian Zahn, Dresden (DE)

(72) Inventor: Christian Zahn, Dresden (DE)

(73) Assignee: LI-TEC BATTERY GMBH, Kamenz (DE)

(21) Appl. No.: 13/697,909

(22) PCT Filed: May 18, 2011
(86) PCT No.: PCT/EP11/02484

§ 371 Date: Feb. 4, 2013

(30) Foreign Application Priority Data
May 28, 2010 (DE) 10 2010 021 908.8

(51) Int. Cl. H01M 10/50

(52) U.S. Cl. CPC H01M 10/5044; H01M 10/5075
USPC 429/120

(57) ABSTRACT

The invention relates to an electrical energy storage cell comprising an electrical energy storage structure, a housing which receives the electrical energy storage structure and surrounds it in a sealed manner, and at least two contact elements which are accessible outside the housing for the electrical connection to electrode regions of the electrical energy storage structure. At least one heat conducting element, which is constructed separately from the electrical energy storage structure and is designed and equipped to absorb heat from the electrical energy storage structure and to release heat to outside of the housing, is disposed inside the housing. The invention also relates to an electrical energy storage device comprising an array of electrical energy storage cells.

The present invention relates to an electrical energy storage cell in accordance with the precharacterizing part of claim 1 as well as an electrical energy storage apparatus having an array of electrical energy storage cells.

### BACKGROUND OF THE INVENTION

Batteries (primary storage) and accumulators (secondary storage) for storing electrical energy are known which are composed of one or more storage cells in which when a charging current is applied, electrical energy is converted into chemical energy in an electrochemical charge reaction between a cathode and an anode in or between an electrolyte and thus stored and in which when an electrical load is applied, chemical energy is converted into electrical energy in an electrochemical discharge reaction. Primary storage devices are normally only charged once and once having been discharged, need to be disposed of, whereas secondary storage devices allow multiple charging and discharging (from a few 100 to more than 10,000 cycles). It is to be noted that, particularly in the automotive sector, accumulators are also referred to as batteries.

Primary and secondary batteries based on lithium compounds have become increasingly important in recent years. They have high energy density and thermal stability, supply a constant voltage at low self-discharge, and are free of the so-called memory effect. The general operational principle of a lithium ion cell is well known; note is made here of publicly accessible sources such as, for example, www.wikipedia.de under the keyword of “lithium ion battery” for further reference.

A lithium ion battery (particularly a secondary battery) can produce considerable heat when charging and discharging. To dissipate excess heat, it is known to use heat-conducting plates arranged between individual cells to cool a battery cell block. DE 10 2008 034 869 A1, for example, discloses a battery comprising a plurality of battery cells forming a cell assembly, whereby one heat-conducting element is arranged between each two adjacent battery cells to absorb the heat from the battery cells and release it to a joint heat-conducting plate below the battery cells. The heat-conducting plate itself is e.g. liquid-cooled.

A battery is known from DE 10 2008 034 860 A1 having an at least substantially flat rectangular cell housing and planar conductors projecting from the narrow sides of the cell housing. The cell housing comprises at least two housing side walls each made from e.g. an aluminum foil 100 μm to 200 μm thick plastic-coated on the outside so as to be electrically insulating. The cell housing accommodates a film stack in which electrode foils (anode and cathode foils) coated with electrochemically active substances are arranged. The electrode foils are separated from one another by a separator and the foil ends sorted according to polarity project from the foil stack at the top of the cell, are combined and bound together and connected to the conductors. The conductors and foil ends of one polarity respectively extend within the cell housing over nearly half the width of the cell. An upward extending narrow tongue of the conductor respectively extends through between the otherwise surrounding interconnected housing side walls and forms the cell pole contact externally of the cell housing. For a cell assembly of such battery cells the DE 10 2008 034 860 A1 teaches providing a heat-conducting plate on the head end (i.e. the top of the cells from which the conductor protrudes) to absorb heat from the conductor via the parallel extending fins between said conductor, wherein casing foil of the cell housing remains situated between the respective conductor and fins. The heat-conducting plate itself is also liquid-cooled in this prior art.

Common to both designs is that the heat can be transferred though the casing foil, which implies a certain thermal resistance. In the first printed publication, heat-conducting elements are arranged between the cells which increases the total length of the cell stack. In the second printed publication, heat is first absorbed in an area outside that region of the stack in which the heat is produced.

### SUMMARY OF THE INVENTION

It is a task of the present invention to improve on the prior art design particularly (but not solely) as concerns the above-cited aspects.

This task is solved by the features of the independent claims. Advantageous further developments of the invention constitute the subject matter of the subclaims.

According to one aspect of the invention, an electrical energy storage cell is proposed, in particular a galvanic secondary cell, comprising an electrical energy storage structure, an enclosure which accommodates and impermeably surrounds the electrical energy storage structure, and at least two contact elements accessible from outside the enclosure to electrically connect to electrode areas of the electrical energy storage structure, whereby at least one heat-conducting element formed separately from the electrical energy storage structure is disposed within the enclosure which is designed and equipped to absorb heat from the electrical energy storage structure and release it outside of the enclosure.

In the sense of the invention, an electrical energy storage cell can refer to any self-contained component designed and equipped to release electrical energy. The electrical energy storage cell can in particular, but not exclusively, be a primary or secondary galvanic storage cell (battery or accumulator cell), preferably secondary, a fuel cell or a capacitor cell. It is particularly, but not exclusively, preferable for the invention to be applicable to flat battery cells, also known as pouch cells or coffee bag cells, or so-called flat cells. An electrical energy storage structure refers to that part of the storage cell which fulfills the electrical characteristics of energy intake, energy storage and energy release; thus the electrochemically active parts of the storage cell in which the charging, discharging and potential converting of electrical energy occur. The electrical energy storage structure can for example exhibit a particularly, but not exclusively, flat film stack or foil sleeve. Foil layers provided with electrochemically active substances, e.g. coated or impregnated, can thereby form electrode areas in the sense of the invention which function like an anode or cathode for the storage structure. Foil layers can further be provided to separate electrode areas of different types from one another (so-called separators). An enclosure in the sense of the invention can also refer to a gas-tight, steam-tight and liquid-tight shell which accommodates the electrical energy storage structure and encloses it on all sides. It can be a foil of pouch or sandwich-like configuration for the electrical energy storage structure and be sealed by a peripheral seam. The enclosure can also be of frame structure with covering sides or be of different configuration. Contact elements in the sense of the invention refer to elements which enable an exchange of electrical energy with the electrode areas, for instance so-called conductor, in contact with the electrode areas within the enclosure and leading out of the enclosure through a wall, a seam or a feedthrough in a part of the enclosure frame. A heat-conducting element in the sense of the invention refers to a structure which is also capable of absorbing and transmitting heat within its material structure. Being separately formed thereby means there is a material separation between the elements of the electrical energy storage structure and the heat-conducting element. The material from which the heat-conducting element is produced is particularly, but not solely, selected based on the aspect of thermal conductivity. It can be for example be produced from a metal such as steel, aluminum or copper or a carbon fiber material, for instance, and can have an anti-corrosive coating.

With an electrical energy storage cell designed according to these aspects of the invention it is also possible to effect a systematic conducting of the excess heat generated in the electrical energy storage structure to the outside of the enclosure, whereby the components serving in the storing of energy and the contacting are kept free from the heat dissipation function.

The heat-conducting element preferably exhibits an at least substantially planar, thin form. Such a heat-conducting element is particularly simple to manufacture, has a large heat transfer surface and low net weight. When the heat-conducting element essentially extends over the largest projected surface of the electrical energy storage structure, this also enables high absorption of heat from the electrical energy storage structure.

In one alternative to an embodiment, the heat-conducting element exhibits an at least substantially thin form which at least substantially surrounds the electrical energy storage structure. Such a design to the heat-conducting element can also enable heat to be absorbed from the electrical energy storage structure on all sides, even should the electrical energy storage structure exhibit a curved outer surface. For example, but not to an exclusive extent, circular and/or cylindrically wound foil packages can also be effectively cooled in this way.

When the heat-conducting element exhibits a pattern of recesses, the heat-conducting element can be manufactured at even lower net weight. If the pattern of recesses is additionally adapted to an expected distribution of the heat generated by the electrical energy storage structure, locally concentrated or locally diminished heat generation from the electrical energy storage structure based on its specific configuration can also be taken into account.

It is particularly preferred for the heat-conducting element to be arranged between the electrical energy storage structure and the enclosure. Such an arrangement also includes a case of two heat-conducting elements being in each case arranged for example between the electrical energy storage structure and the enclosure on the two flat sides of a flat foil sleeve of the electrical energy storage structure. This also enables a particularly simple assembly of the electrical energy storage structure to be realized. Additionally or alternatively hereto, the electrical energy storage structure can comprise at least two subsections and the heat-conducting element can be arranged between two of said subsections. Such an arrangement also allows heat to be discharged directly from the interior of the electrical energy storage structure.

The heat-conducting element preferably has an electrically insulating coating or the electrical energy storage structure has an electrically insulating coating or interlayer or casing which separates the electrical energy storage structure from the heat-conducting element. This is particularly advantageous when the heat-conducting element is made of an electrically conductive material since doing so can prevent unintentional charge transfers and possible short circuits.

It can prove advantageous to dispose means for improving thermal conduction, particularly a heat conductive paste, on the heat-conducting element and/or the coating or interlayer or casing of the electrical energy storage structure.

The heat-conducting element can extend through the enclosure such that the heat absorbed can be emitted directly to a structure provided outside of the electrical energy storage cell. Arranging same in a surface area of the electrical energy storage cell in or at which no contact elements are disposed realizes an advantageous separation of current paths and cooling paths.

The heat-conducting element can exhibit a connecting structure external of the enclosure which is designed and equipped to realize a connection with an external heat sink. A connection in terms of the invention refers to a heat transferring contact. This allows the heat from the cell to be effectively discharged. Should the connecting structure comprise a heat accumulator structure which has a higher heat storage capacity than other areas of the heat-conducting element, particularly areas situated inside the enclosure, this creates a thermal buffer which enables consistent operation of the heat sink, even with brief increases in heat production.

It is preferable for the heat-conducting element to be spring mounted within the enclosure, and particularly such that it is pressed toward an external heat sink. Doing so ensures a reliable contact between the heat-conducting element and an external heat sink and can reduce mechanical stresses.

A further aspect of the invention also addresses an electrical energy storage apparatus having a plurality of electrical energy storage cells preferably combined into a block designed in accordance with the above description. Specifically given a block in which electrical energy storage cells are densely stacked, the inventive arrangement of a heat-conducting element within the cells' enclosure can exhibit specific advantages since other cooling approaches are often not possible or call for additional components or structural measures within the block. The inventive arrangement allows the cells to be more densely packed without requiring any interspaces for circulating coolant such as air or additional cooling elements.

The apparatus is preferably provided with a cooling structure which is designed and equipped to absorb heat from the heat-conducting elements of the electrical energy storage cells, whereby said cooling structure is designed and equipped to be disposed in or on a housing structure accommodating an electrical energy storage cell block or forms a part of said housing structure. The cooling structure can also function as a joint heat sink for the heat-conducting elements of the cells in the block and thereby also contribute to equalizing block's heat balance.

It is particularly preferred for the cooling structure to be designed and equipped to being cooled by means of a fluid, preferably a liquid, particularly water and/or an alcohol such as pure glycol or a glycol mixture. Liquid cooling also realizes an effective and efficient dissipating of the heat absorbed by the heat-conducting elements. The cooling structure is thereby preferably designed and adapted to connect to a coolant supply circuit so as to ensure efficient cooling of the apparatus.

The above and further features, objects and advantages of the present invention will become more clearly evident from the following description which references the accompanying drawings.

### BRIEF DESCRIPTION OF THE DRAWINGS

The figures show:

FIG. 1 a frontal view of a battery cell according to a basic embodiment of the present invention;

FIG. 2 a sectional view of the battery cell from FIG. 1 sectioned along the II-II line in FIG. 1 and looking in the direction of the associated arrow;

FIG. 3 an enlarged depiction of the battery cell from FIG. 2 vertically exaggerated in the direction of thickness;

FIG. 4 a frontal view of a heat baffle plate in the battery cell of FIG. 1;

FIG. 5 a sectional view as in FIG. 3 showing a battery cell in a variation of the embodiment;

FIG. 6 a sectional view as in FIG. 3 showing a battery cell in a further variation of the embodiment;

FIG. 7 a cross-sectional depiction of different embodiment variations A to F of a base of the heat baffle plate with a heat sink;

FIG. 8 a depiction of three production/assembly stages A to C in manufacturing a battery cell having a heat baffle plate as a further variation of the embodiment of the present invention; and

FIG. 9 a frontal view of a battery block and a heat sink in a further embodiment of the present invention.

It is to be noted that the representations provided in the figures are schematic and are limited to reproducing the features most important to understanding the invention. It is also pointed out that the dimensions and proportions reproduced in the figures are attributable solely to providing clarity to the depictions and are in no way to be considered limiting unless stated otherwise in the description.

### DESCRIPTION OF THE PREFERRED EMBODIMENTS OF THE INVENTION

The following will reference the drawings in describing a preferred embodiment of the present invention and various modifications and embodiment variations thereof in greater detail. Identical or equivalent components or components of equal or equivalent action are thereby identified by the same or similar reference numerals.

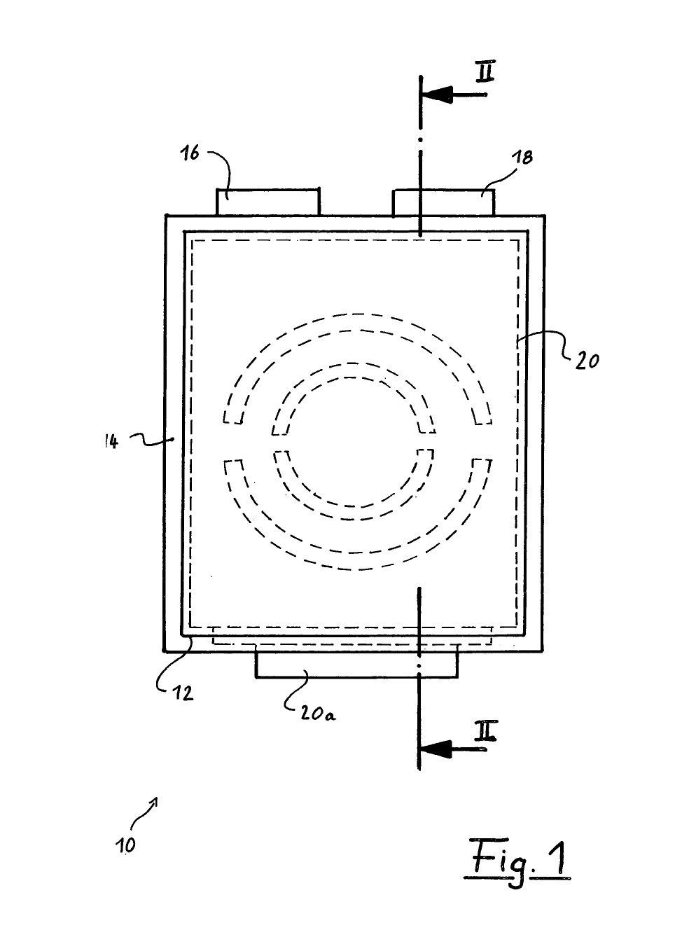

A basic embodiment of a battery cell of the present invention will first be described with reference to FIGS. 1 to 4. FIG. 1 thereby shows a frontal view of a battery cell 10 having a heat baffle plate 20; FIG. 2 shows a sectional side view of the battery cell 10 along the II-II line from FIG. 1; FIG. 3 is an enlarged depiction of the FIG. 2 sectional view exaggerated in the thickness direction in order to clarify the structure of the battery cell 10 in detail; and FIG. 4 shows just the heat baffle plate 20 in the same view as in FIG. 1.

The battery cell 10 in the present embodiment is a lithium ion accumulator cell of coffee bag or pouch type. In this type of battery, a substantially prismatic, cross sectionally rectangular main body 12 is surrounded by a thin edge 14 in accordance with the FIG. 1 representation. Two conductors 16, 18 project upward from the top of the battery cell 10 while a base 20a of a heat baffle plate 20 projects downward from the underside. FIG. 1 depicts where the heat baffle plate 20 is situated within the battery cell 10 by means of dashed lines.

In accordance with the FIG. 2 representation, the main body 12 is substantially formed by an electrochemically active foil package 22 functioning as an electrical energy storage structure in the sense of the invention, the design of which will be clarified more precisely with reference to FIG. 3. Two casing foils 24 form the walls of the cell 10 and accommodate the foil package 22 between them and extend to the sides as well as above and below the dimensions of the foil package 22 and are welded there to be fluid, steam and gas-tight in order to form the edge 14 of the cell 10. The casing foils 24 thus form an enclosure in the sense of the invention. The conductors 16, 18 (only one conductor 18 is visible in FIG. 2) extend outward through a seam in the casing foils 24 and are contact-accessible at that point. The conductors 16, 18 thus form contacting elements in the sense of the invention.

The heat baffle plate 20 is arranged between the foil package 22 and one of the walls 24 and extends substantially across the entire flat side of the foil package 22 (see FIG. 1). The heat baffle plate 20 thus extends at least substantially over a largest projected area of the foil package 22. The heat baffle plate 20 is bent twice in the lower area in order to form a base 20a which extends downward through the seam of the casing foils 24 to the outside.

It is noted that any given recesses there may be in the heat baffle plate 20 (see further below in the description for more on this) are not shown in any greater detail in FIG. 2 nor in any of the other sectional views.

The following will draw on FIG. 3 in describing the design of the cell 10, particularly the foil package 22, in greater detail. The FIG. 3 depiction thereby corresponds to the sectional representation of FIG. 2, although with the thickness direction of the cell 10 being vertically exaggerated.

In accordance with the FIG. 3 depiction, the foil package 22 comprises in the following order: an anode collector foil 26 having an anode layer 28, a separator layer 30, two cathode layers 32 arranged on either side of a cathode collector foil 34, a further separator layer 30 and a further anode layer 28 on a further anode collector foil 26.

The cathode layers 32 in the present embodiment consist of a lithium metal oxide or a lithium metal compound, the graphite anode layers 28, and the separator layers 30 are formed from a fibrous material of electrically non-conductive fibers, wherein the fibrous material is coated with an inorganic material at least on one side. EP 1 017 476 B1 describes such a separator and a method for its manufacture. A separator having the above-cited properties and marketed under the name of “Separion” is currently available from Evonik AG, Germany.

The cathode layers 32, the anode layers 28 and the separator layers 30 can be manufactured as independent foil structures or formed into an e.g. deposited layer structure on the collector foils 34, 26. The electrode area containing the foils or layers 26 to 36, which can also be understood as an electrical energy storage structure in the sense of the invention, is soaked or impregnated with an electrolyte, evacuated and anhydrous. The cathode collector foils 34 in the present embodiment 16 are composed of aluminum; the anode collector foils 26 of copper. Known materials such as copper, aluminum or other metals or alloys thereof are to be selected for the current conductors 16, 18, ensuring a suitable material pairing with the collecting foils 34, 26. In particular, the conductor 16 on the cathode side advantageously comprises aluminum whereas the conductor 18 on the anode side advantageously comprises copper. Further alloying constituents can be added to improve the mechanical properties; the conductors 16, 18 can be silver or gold-plated to improve the contact (reduce the contact resistance) and/or prevent corrosion. In the present embodiment, the casing foil 24 comprises three layers which ensures both sufficient mechanical stability as well as resistance to electrolyte material and good electrical and thermal insulation. Thus, in a manner known per se, the casing foil comprises an inner layer of a thermoplastic such as polyethylene or polypropylene, a middle layer of a metal such as aluminum, and an outer layer of a plastic such as polyamide.

Conductor strips 26a extend from the cathode collector foils 26 to the conductor 18 and one conductor strip 34a extends from the anode collector foil 34 to conductor 16 (concealed in the figure). The conductor strips 26a, 34a are already connected to the respective conductor 16, 18 within the casing foil 24. Doing so establishes a connection between the conductors 16, 18 and the respective electrode areas (cathode/anode areas) of the foil package 22. Each conductor strip 26a, 34a is approximately the width of the associated conductor 16, 18.

The foil package 22 structured as described above is partly surrounded by a protective film 36 which in the present embodiment abuts the flat side bordering the heat baffle plate 20 as well as the lower narrow side of the foil package 22. The protective film 36 serves substantially in reliably electrically isolating the heat baffle plate 20 arranged between the foil package 22 and the casing foil 24 from the foil package 22. The protective film 36 also has good thermal conductivity. A (not explicitly shown) heat conducting paste can also be additionally disposed between the heat baffle plate 20 and the foil package 22.

An internal space 38 at the upper region of the battery cell 10 is likewise filled with separator or insulating material in order to prevent unwanted contacting.

It is to be understood that the structure of cell 10 is depicted in simplified form in FIG. 3 for clarification purposes. There can be many more layers of anode and cathode foils with the respective coatings and separators. Anode collecting foils 26 which are not arranged at the edge but rather within the foil stack 22 can likewise exhibit anode layers 28 on both sides as with the two cathode layers 32 of the cathode collector foil 34 shown in FIG. 3.

FIG. 4 shows a frontal view of the heat-conducting plate 20 according to FIG. 1 on its own.

In accordance with the FIG. 4 depiction, the heat baffle plate 20 exhibits a substantially flat heat transfer surface 20b which gives way to the lower region at the base 20a. The heat baffle plate 20b is made from a good thermal conductor such as e.g. aluminum or a carbon fiber material and has a thickness of approximately 0.5 mm. Further requirements for the heat baffle plate relate to the formability and the corrosion resistance within the highly corrosive environment of the cell interior. A (not explicitly shown) coating of the heat baffle plate 20 which is resistant to disruptive discharge can be provided as a safety precaution in addition to the protective film 36; such a coating or other preventive measure is mandatory in the event no protective film 36 is provided.

In accordance with the FIG. 4 depiction, recesses (holes or windows) 20c are formed in the heat transfer surface 20b of the heat baffle plate 20. Said recesses 20c take account of the fact that there can be uneven temperature distribution within the battery cell 10. “Hot spots” (areas of particularly high heat generation) can in particular be specifically cooled by the heat baffle plate, while less heat is discharged through the recesses 20c of the plate in the peripheral areas; a so-called “k×A modulation” is thus realized whereby k indicates a specific transmission heat flow in [W/m²K] and A indicates a component surface in [m²]. The heat baffle plate 20 is thereby particularly adapted to an expected distribution of generated heat in the foil package 22. Doing so allows homogenizing temperature distribution over the surface of the battery cell 10.

As FIG. 4 shows, the heat baffle plate 20 exhibits a smaller width in the area of the base 20a than in the area of the heat transfer surface 20b. This design also affords a sufficient length to the seam between the casing foils 24 in the lower edge 14 area in order to ensure the seam's impermeability and stability.

As is evident from the above description, the heat baffle plate 20 of the embodiment in its modifications and variants is a heat-conducting element in the sense of the invention constructed separately from the electrical energy storage structure which is designed and equipped to absorb heat from the foil package 22 understood as an electrical energy storage structure and discharge it externally of the enclosure formed by the casing foils 24.

Due to the direct cooling connection, heat transfer resistance between the foil stack 22 as the electrical energy storage structure in the sense of the invention and the heat baffle plate 20 can be minimized. The heat transfer is not as slow compared to external cooling; the response time can be improved. Temperature spikes can thereby be avoided, whereby the consistent performance and operational safety of the cell as well as the battery arrangement with its plurality of cells can be improved as a whole. The strict separation of current path and cooling path thereby realized by the conductors 16, 18 being arranged at the top of the cell 10 but the heat-conducting base 20a of the heat baffle plate 20 being arranged at the bottom of the cell 10 likewise contributes to operational safety.

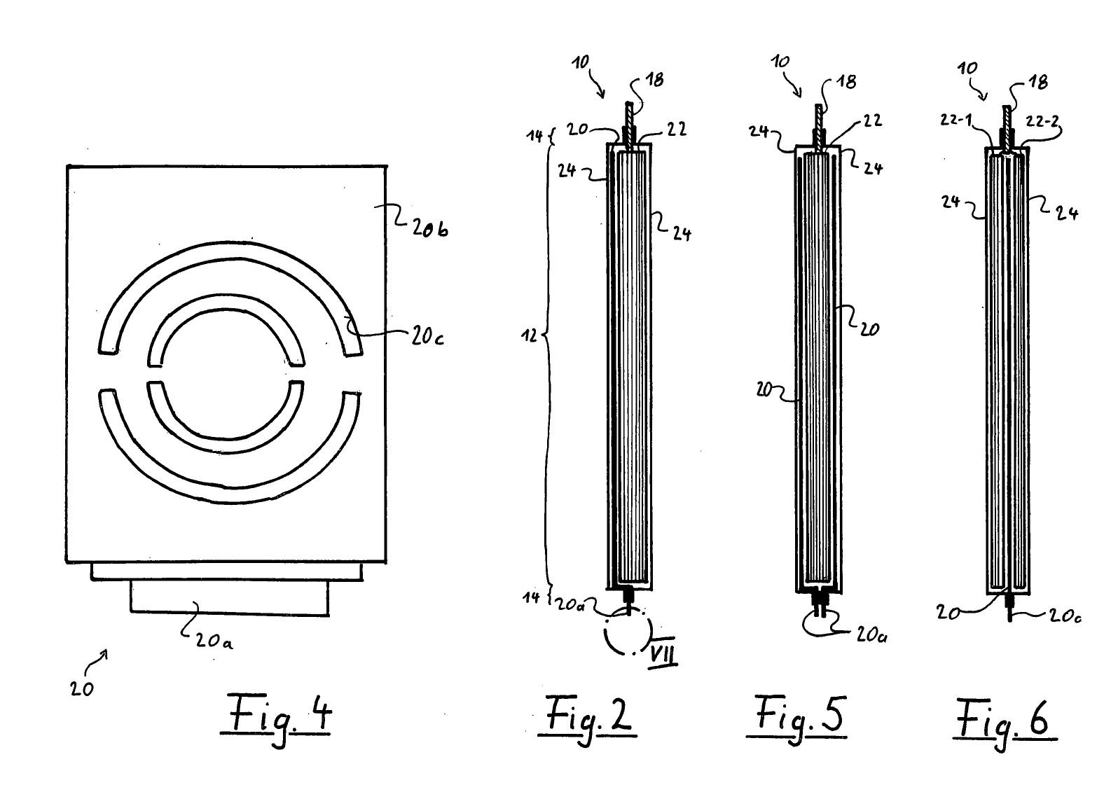

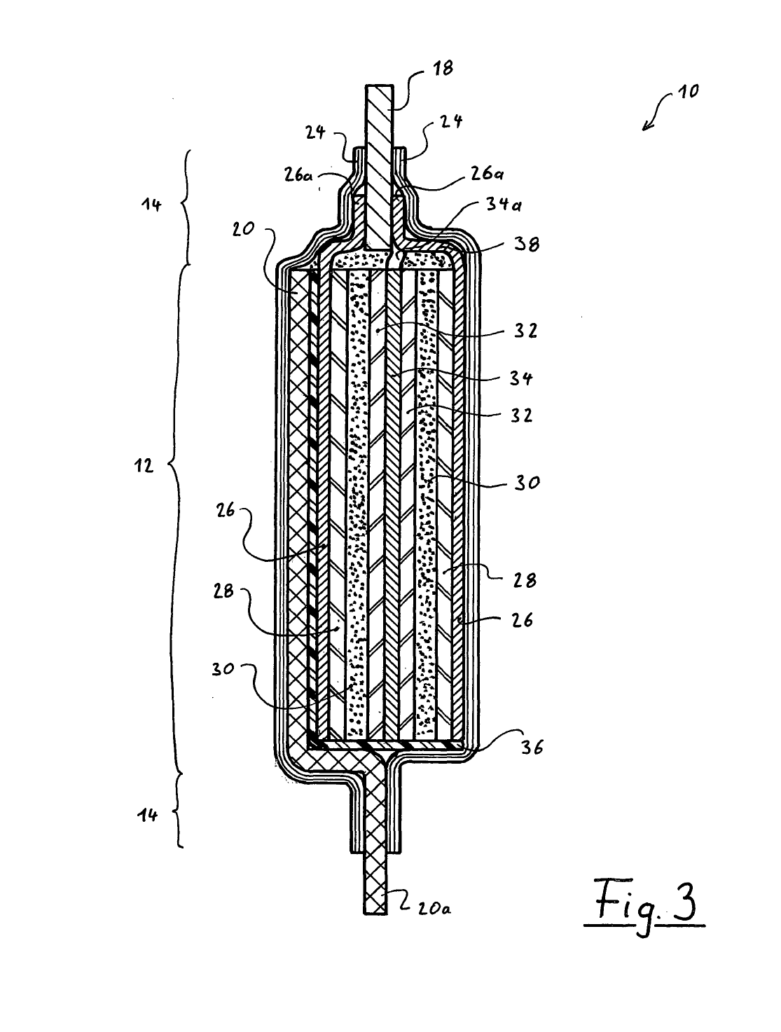

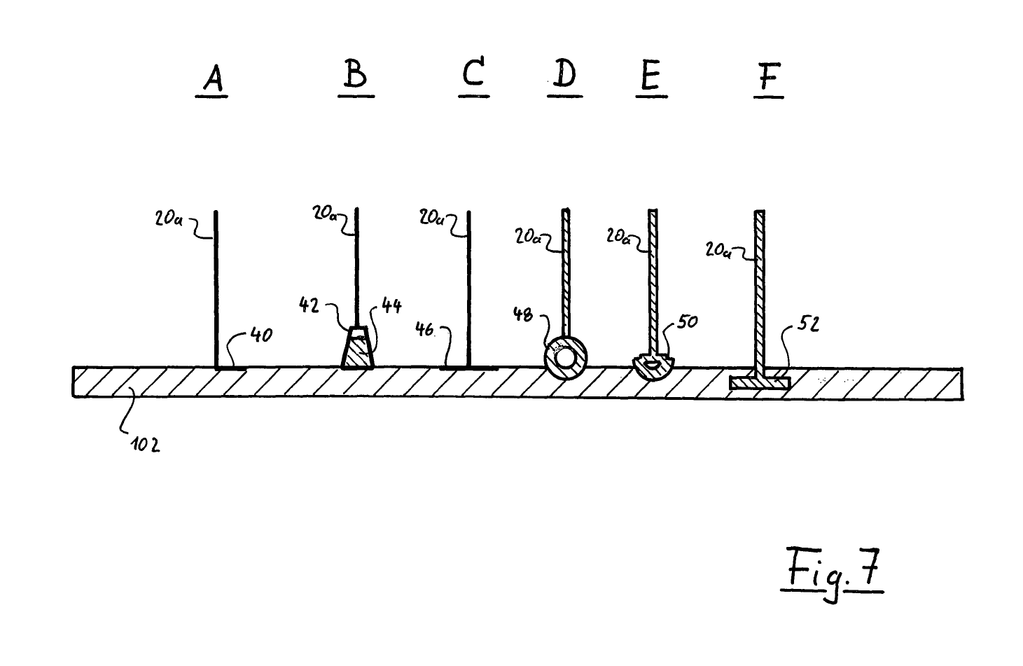

FIG. 5 shows a variation of the presently described embodiment in a view analogous to that of FIG. 2. Apart from the explicitly cited differences described in the following, the previous clarifications of the embodiment also apply to its present variation.

According to the FIG. 5 depiction, two heat baffle plates 20 are provided, respectively arranged on either side of the foil package 22 between the latter and a casing foil 24. The base 20a of both heat baffle plates 20 projects outwardly between the casing foils 24 at that point where the latter meets the edge 14 at the underside of the battery cell 10. This variation can double the total surface area available for heat transfer. In addition, the heat output in the thickness direction of the cell 10 can be homogenized and the heat transfer direction symmetrical relative to a cell center plane.

In the present embodiment variation, the heat baffle plates 20 only have a thickness of approximately 0.25 mm, which corresponds to half of the value in the case of just one heat baffle plate 20 per cell 10. A protective film as described above (cf. protective film 36 in FIG. 3) extends as needed in this variation over both flat sides of the foil stack in order to realize an effective separation of the two heat baffle plates.

As depicted in FIG. 5, the bases 20a of the heat baffle plates 20 project as a double layer through the edge seam between the casing foils 24. In order to prevent possible danger of leakage, a further (not explicitly shown) variant can provide for the bases 20a of the heat baffle plates 20 to only extend over approximately half of the width shown in FIG. 4 so that the bases 20a would be offset in the width direction by the traversing seam (in this variant, the bases 20a would be arranged on the bottom similar to how the conductors 16, 18 are arranged at the top of the cell 10).

FIG. 6 shows a further variation of the presently described embodiment in a view analogous to that of FIG. 2. Apart from the explicitly cited differences described in the following, the previous clarifications of the embodiment also apply to its present variation.

According to the FIG. 6 depiction, two sub-packages 22-1, 22-2 arranged one behind the other with facing flat sides in the thickness direction of the battery cell 10 are provided in place of the one foil package and a heat baffle plate 20 is arranged in the middle between said sub-packages 22-1, 22-2. The heat output in the thickness direction of the cell 10 can likewise be homogenized by this arrangement; the heat transfer direction is symmetrical relative to a cell center plane.

The cooling plate in this variation has a thickness of approximately 0.5 mm, which corresponds to the value in the case of the lateral arrangement of a heat baffle plate 20 in the cell 10. The heat baffle plate 20 is not curved in the area of the base 20a but continuously straight. However, as in the depiction of the embodiment in FIG. 4, the heat baffle plate 20 can be of smaller width in the area of the base 20a than in the area of the heat transfer surface 20b.

FIG. 7 shows a plurality of embodiment variants for the base 20a of the heat baffle plate 20 together with a heat-conducting plate 102. The heat-conducting plate 102 is a component of a housing not presently depicted in greater detail and serves as an (external) heat sink for the heat baffle plate 20 of the plurality of battery cells 10 arranged in a block or as a cooling structure in the sense of the invention respectively. It is self-evident that the heat baffle plates 20 of the battery cells 10 of one block normally have the same design to the base 20a.

Different structural designs are integrated into the figure solely for reasons of illustrative economy.

In the embodiment variant identified by the letter “A,” the end of the base 20a exhibits a bend 40 atop the heat-conducting plate 102. The bend 40 provides a comparatively large surface for a heat transfer between the base 20a and the heat-conducting plate 102.

In the embodiment variant identified by the letter “B,” the end of the base 20a exhibits a hollow body 42 which is trapezoidal in cross section and filled with a filler material 44. A base side 42a of the hollow body 42 provides a comparatively large surface for a heat transfer between the base 20a and the heat-conducting plate 102. The filler material 44 provides a mass which acts as a heat accumulator and can contribute to homogenizing the temperature distribution in the heat-conducting plate 102. The hollow body 42 can be welded to the base 20a or can be integrally formed with same.

In the embodiment variant identified by the letter “C,” the end of the base 20a exhibits a broadening 46 atop the heat-conducting plate 102. This broadening 46 provides an even larger surface than a mere bend for heat transfer between the base 20a and the heat-conducting plate 102. The broadening 46 can be welded to the base 20a as a plate or can be integrally formed with same.

In the embodiment variant identified by the letter “D,” the end of the base 20a exhibits a tubular profile 48 extending across the width of the base 20a atop the heat-conducting plate 102 and penetrating it to a certain depth. This can be effected by it being pressed in or the heat-conducting plate 102 comprising correspondingly provided grooves (not explicitly shown). The tubular profile 48 exhibits a circular cross section and provides a thermal mass by virtue of its volume. The tubular profile 48 likewise increases the surface available for heat transfer between the base 20a and the heat-conducting plate 102. The tubular profile 48 can be welded to the base 20a or be integrally formed with same. In a further variant, the tubular profile can project beyond the base 20a in the width direction in order to further enlarge the contact surface and the thermal mass.

In the embodiment variant identified by the letter “E,” the end of the base 20a exhibits a tubular profile 50 which only differs from the “D” embodiment variant in that it exhibits a semi-circular cross section.

In the embodiment variant identified by the letter “F,” the end of the base 20a exhibits a broadening 52 penetrating into the heat-conducting plate 102. The broadening 46 provides a large surface area and by virtue of the full embedding of the heat-conducting plate 52, provides good contact for heat transfer between the base 20a and the heat-conducting plate 102 in the heat-conducting plate 52. The broadening 46 can be welded to the base 20a as a plate or can be integrally formed with same.

It is clear from the FIG. 7 depiction and the above description that the base 20a of the heat baffle plate 20 can have different designs as a connecting structure in the sense of the invention and can be disposed to realize a physical contact with an external heat sink.

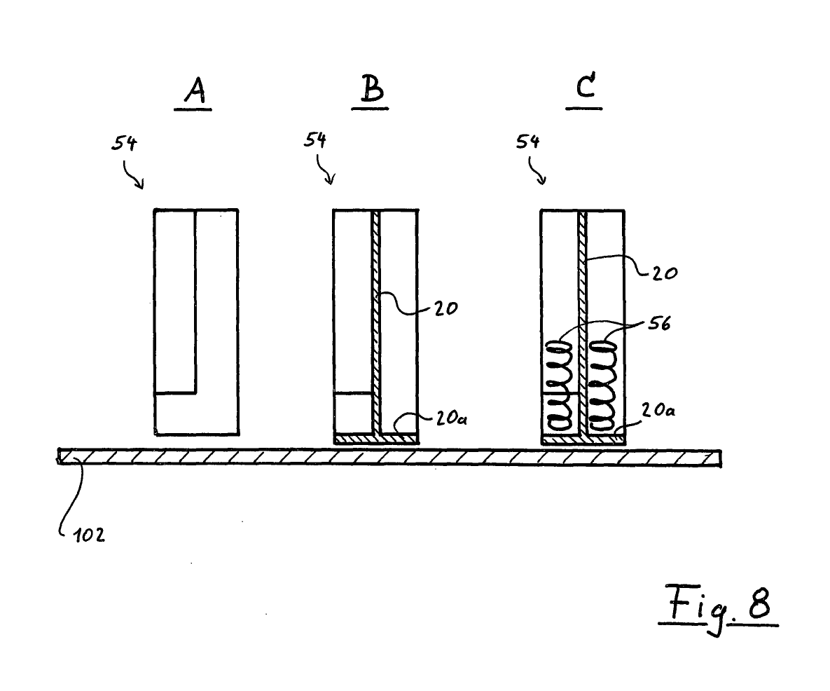

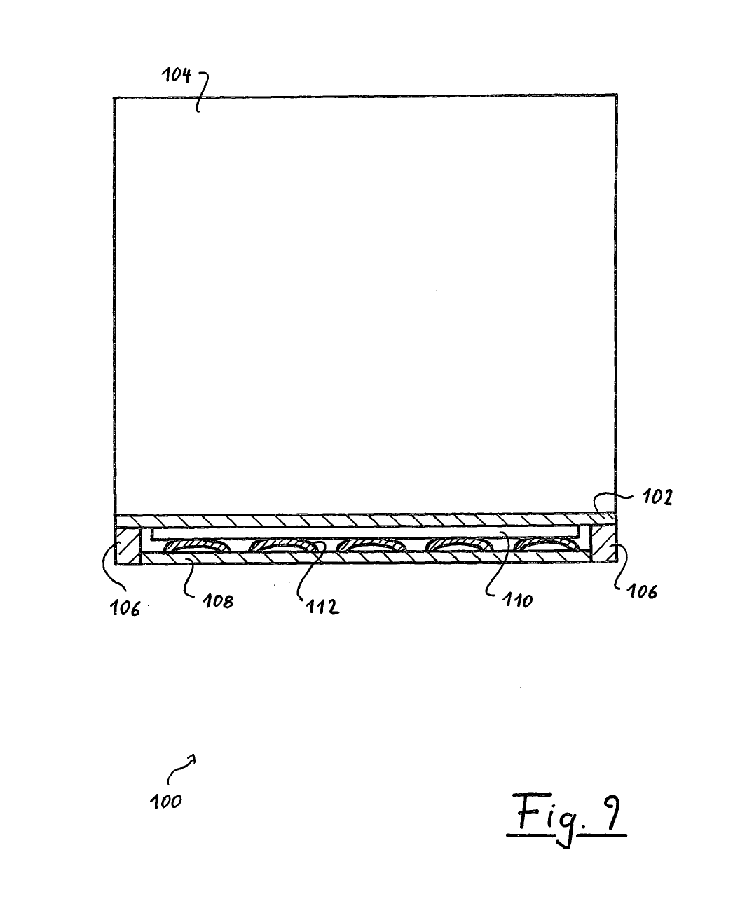

FIG. 8 depicts three production stages in the manufacturing of a battery cell 10 in a further variation of the embodiment or one of its modifications or embodiment variants. In similar manner as above, one heat-conducting plate 102 is depicted for all three production stages. The heat-conducting plate 102 is a component of a not-shown housing and serves as a heat sink for the heat baffle plate 20 of a plurality of battery cells arranged in one block. The battery cell is only suggested schematically in this figure by means of a frame 54.

The production stage identified by the letter “A” shows a frame 54 facing the heat-conducting plate 102. The frame 54 can serve simply as a means in manufacturing and assembling the battery cell or can remain as part of the cell housing (an enclosure) or a built-in structure for the battery cell.

In the production stage identified by the letter “B,” a heat baffle plate 20 is inserted into the frame 54 (wherein for the purpose of the example and without limiting the generality, the base 20a corresponds to the embodiment variants C or F from FIG. 7).

In the production stage identified by the letter “C,” spring elements 56 are inserted into the frame 54 such that the base 20a of the heat baffle plate 20 is pressed downward (i.e. toward the heat-conducting plate 102).

In not-shown production stages, a foil package 22 or sub-packages 22-1, 22-2 are inserted into the frame and the arrangement tightly sealed—with evacuation of the internal space occurring as needed.

The spring mounting of the heat baffle plate 20 in the cell can also ensure good contact with the heat-conducting plate 102. It is reiterated that the FIG. 7 depiction is highly schematic.

FIG. 9 shows a further embodiment of the invention's battery 100 having a plurality of battery cells in a frontal sectional view. The line of sight corresponds to the frontal view of FIG. 1.

In accordance with the preceding description, a battery 100 comprising a plurality of battery cells (not explicitly shown) constitutes an embodiment along with its variations and embodiment modifications. Heat baffle plates of the battery cells are connected to a joint heat-conducting plate 102 in accordance with the preceding description. The battery cells are stacked with facing flat sides under a schematically depicted cover 104. The heat-conducting plate 102 and the elements arranged underneath it are shown in cross section in FIG. 9, while the cover 104 is shown unsectioned. In addition to the cells, the cover 104 also accommodates further electrical components (controller, sensor system etc.; not explicitly shown) needed to operate the battery 100.

According to the FIG. 9 depiction, the heat-conducting plate 102 rests on two bars 106 which are connected together in the width direction by means of a base plate. A cooling plate or evaporator plate 110 is arranged in flat contact below the heat-conducting plate 102. The evaporator plate 110 is pressed upward by plate springs 112 which are arranged in a hollow space between the base plate 108 and the evaporator plate 110. The plate springs 112 serve in supporting and tolerance compensation on the one hand as well as providing uniform contact pressure between the evaporator plate 110 and the heat-conducting plate 102 on the other.

The spring mounting of the evaporator plate 110 and the pressure on the heat-conducting plate 102 minimizes thermal resistance. The cooling plates 112 can be structurally simplified and the fluid flow in the cooling plate 112, particularly as regards thermal conductivity and the design of the connections, can be freely designed independently of the type and design of the cells. Fluid-conducting parts can be disposed externally of the main housing (heat-conducting plate 102, cover 104), which can reduce the possible risks of for example, but not exclusively, short-circuits or chemical reactions. The plug-and-play installation enabled as a whole reduces costs and potential sources of error.

The present invention was described above drawing on embodiment examples having a plurality of variations and embodiment variants. It goes without saying that the scope of the invention is in no way limited by the preceding description but rather encompasses the full entirety of the claims.

In accordance with the preceding description, the conductors 16, 18 are contacting elements in the sense of the invention. Other structural solutions can also be selected for the contacting elements within the meaning of the invention. Contact surfaces can for example be disposed flush with one or both flat sides of the main body or one or more of its edges connected to the electrode area (foil package 22) inside the cell. As a further of many conceivable variants, contacts can be formed as a type of battery snap as known for example from 9V block batteries.

As an electrical energy storage structure in the sense of the invention in accordance with the preceding description, a foil package 22 or sub-packages 22-1, 22-2 have a flat rectangular shape. An electrical energy storage structure in the sense of the invention can also exhibit a different shape. Alternatively, for example, but not exclusively, a cylindrically wound foil stack can be provided with a correspondingly formed enclosure. Instead of a flat stack, the foil layers can also form a flat coil.

In accordance with the preceding description, casing foils 24 are provided as an enclosure within the meaning of the invention. Alternatively, for example, however not exclusively, frame-style structures or cup-shaped casings can be provided as the enclosure in the sense of the invention. The expert can also modify as needed the layer structure of the casing foils 24 as described in conjunction with the embodiment.

It goes without saying that the structure of the foil package 22 described in conjunction with the embodiment serves solely for descriptive purposes and is in no way to be considered limiting in terms of the inventive concept which can be applied to any type of electrochemical storage cell in which generated heat is to be dissipated.

It is also self-evident that the dimensions and proportions can widely vary depending on the type, capacity and cell voltage of an electrical energy storage cell and is in no way limited to the conditions as depicted. In particular, the cited plate thickness of the heat baffle plate 20 can be appropriately selected as a function of battery type and size.

Instead of a joint arrangement, the conductors can be formed on opposite narrow top sides of the cell or completely differently as suggested in the abstract of the invention. However, to realize a separation of the current and cooling paths, it is advantageous for the conductors to be situated in other areas of the cell than a connecting structure for connecting the heat baffle plate.

It can also be provided for the base 20a of the heat baffle plate 20 to terminate within the edge 14 (i.e. within the seam of the casing foils 24) and an external thermal terminal to be effected, for example by means of clips or clamps which grip the edge 14 from below. Although such a variant dispenses with the advantage of direct thermal conduction, it can still further reduce potential danger of leakage from the seam. Such a design can be combined for example, but not exclusively, with the F embodiment variant from FIG. 7 such that the base 20a depicted in same is fixedly arranged in the heat-conducting plate 102 and physically connected to a clip or clamp as stated above.

The cooling plate or evaporator plate 110 can be connected to a coolant supply circuit. Liquids having high thermal capacity and sufficient thermal stability are for example, but not exclusively, conceivable as said coolant. Particularly, but not exclusively, reliable are mixtures of water and glycol, for example in a 50:50 mixture ratio. The coolant inflow can be prewarmed when the battery 100 is started up, particularly given a cold ambient temperature, including by preheating until the cells 10 reach a predetermined minimum temperature. In the process, the heat baffle plates function as heating elements. The operating temperature of the cells 10 can in this way be kept within an optimum and/or permissible range even during operation of the battery 100.

### LIST OF REFERENCE NUMERALS

10 battery cell
12 main body
14 edge
16, 18 conductor
20 heat baffle plate
20a base
20b heat transfer surface
20c recess
22 foil package (active part)
22a, 22b sub-packages (variation)
24 wall (casing foil)
26 anode collector foil
26a conductor tongue
28 anode layer
30 separator layer
32 cathode layer
34 cathode collector foil
34a conductor tongue
36 protective film
38 internal space
40 bend
42 hollow body
44 filler material
46 broadening
48 tubular profile
50 tubular profile
52 broadening
54 frame
56 spring element
100 battery (cell block)
102 heat-conducting plate
104 cover
106 bar
108 base plate
110 cooling plate (evaporator plate)
112 plate spring

It is explicitly noted that the above reference numeral list is an integral part of the description.

1-15. (canceled)

16. An electrical energy storage cell, comprising:
an electrical energy storage structure;
an enclosure which accommodates and impermeably surrounds the electrical energy storage structure; and
at least two contact elements accessible from outside the enclosure to electrically connect to electrode areas of the electrical energy storage structure, wherein at least one heat-conducting element formed separately from the electrical energy storage structure is disposed within the enclosure which is designed and equipped to absorb heat from the electrical energy storage structure and release it outside of the enclosure, wherein the heat-conducting element exhibits a pattern of recesses adapted to an expected distribution of the heat generated by the electrical energy storage structure.

17. The electrical energy cell according to claim 16, wherein the electrical energy cell is a galvanic secondary cell.

18. The electrical energy storage cell according to claim 16, wherein the heat-conducting element exhibits a substantially planar, thin form.

19. The electrical energy storage cell according to claim 18, wherein the substantially planar, thin form essentially extends over the largest projected surface of the electrical energy storage structure.

20. The electrical energy storage cell according to claim 16, wherein the heat-conducting element exhibits a substantially thin form which at least substantially surrounds the electrical energy storage structure.

21. The electrical energy storage cell according to claim 16, wherein the heat-conducting element is arranged between the electrical energy storage structure and the enclosure.

22. The electrical energy storage cell according to claim 16, wherein the electrical energy storage structure comprises at least two subsections and the heat-conducting element is arranged between two of said subsections.

23. The electrical energy storage cell according to claim 16, wherein the heat-conducting element has an electrically insulating coating or the electrical energy storage structure has an electrically insulating coating or interlayer or casing which separates the electrical energy storage structure from the heat-conducting element.

24. The electrical energy storage cell according claim 16, wherein means for improving thermal conduction, particularly a heat conductive paste, are disposed on the heat-conducting element and/or the coating or interlayer or casing of the electrical energy storage structure.

25. The electrical energy storage cell according to claim 16, wherein the heat-conducting element extends through the enclosure.

26. The electrical energy storage cell according to claim 25, wherein the heat-conducting element extends through the enclosure in a surface area of the electrical energy storage cell in or at which no contact elements are disposed

27. The electrical energy storage cell according to claim 25, wherein the heat-conducting element exhibits a connecting structure external of the enclosure which is designed and equipped to realize a connection with an external heat sink.

28. The electrical energy storage cell according to claim 27, wherein the connecting structure comprises a heat accumulator structure which has a higher heat storage capacity than other areas of the heat-conducting element.

29. The electrical energy storage cell according to claim 28, wherein the heat accumulator structure has a higher heat storage capacity than areas of the heat-conducting element that are situated inside the enclosure.

30. The electrical energy storage cell according to claim 16, wherein the heat-conducting element is spring mounted within the enclosure, and particularly such that it is pressed toward an external heat sink.

31. An electrical energy storage apparatus comprising:
a plurality of electrical energy storage cells according to claim 16.

32. The electrical energy storage apparatus according to claim 31, wherein the plurality of electrical energy storage cells is combined into a block.

33. The electrical energy storage apparatus according to claim 31, wherein a cooling structure is provided which is designed and equipped to absorb heat from the heat-conducting elements of the electrical energy storage cells, wherein the cooling structure is designed and equipped to be disposed in or on a housing structure accommodating an electrical energy storage cell block or forms a part of said housing structure.

34. The electrical energy storage apparatus according to claim 33, wherein the cooling structure is designed and equipped to being cooled by means of a fluid.

35. The electrical energy storage apparatus according to claim 33, wherein the cooling structure is designed and equipped to being cooled by means of water and/or an alcohol, and the cooling structure is designed and adapted to connect to a coolant supply circuit.
